(19) United States
(12) Patent Application Publication
(10) Pub. No.: US 2011/0197763 A1
(43) Pub. Date: Aug. 18, 2011

(54) Material for eliminating oxides of nitrogen with lamellar structure

(76) Inventors: Thierry Becue, Paris (FR); Philippe Villeret, Rueil Malmaison (FR)

(21) Appl. No.: 10/484,696

(22) PCT Filed: Jul. 24, 2002
(86) PCT No.: PCT/FR2002/002642

§ 371 Date: Apr. 18, 2011

(30) Foreign Application Priority Data
Jul. 25, 2001 (FR) 01/10046

(51) Int. Cl. B01D 53/02; B01J 20/02; B01J 20/06; B01J 20/08; B01J 20/28; B01J 20/10; B01J 20/18

(52) U.S. Cl. 95/129; 502/400; 502/414; 502/406; 502/407; 502/415; 502/87

(57) ABSTRACT

The invention concerns materials for eliminating oxides of nitrogen NO and NO₂ present in exhaust gases, in particular from the internal combustion engines of automotive vehicles operating in a medium which is super-stoichiometric in oxidising agents, which can adsorb oxides of nitrogen then desorb the oxides of nitrogen by elevating the temperature with respect to the adsorption temperature or by passage of a rich mixture, said materials comprising mixed oxides the metals of which are in octahedral coordination, with the octahedra connecting together so that the structure generates lamellae.

Said materials adsorb oxides of nitrogen by insertion and do not become poisoned in contact with oxides of sulphur and carbon contained in the gases.

In the presence of a group VIII metal, said materials are capable of eliminating oxides of nitrogen adsorbed by reduction during the passage of a rich mixture.

### TECHNICAL FIELD

The present invention relates to materials that encourage elimination, by adsorption, of oxides of nitrogen (NO and NO₂, usually termed NOₓ) present in a gas mixture which may be super-stoichiometric in oxidising compounds, and in particular in oxygen, said materials not being poisoned by the sulphur-containing products present in those gases. The invention is applicable to eliminating oxides of nitrogen (NOₓ) present in the exhaust gases from automotive vehicles, in particular from vehicles functioning with diesel fuel.

### PRIOR ART

The high toxicity of oxides of nitrogen and their role in the formation of acid rain and tropospheric ozone have led to the instigation of strict regulations limiting the discharge of such compounds. In order to satisfy those regulations, it is generally necessary to eliminate at least a portion of such oxides present in exhaust gases from automotive or stationary engines and from turbines.

The elimination of oxides of nitrogen by thermal decomposition or, as is preferable, by catalytic decomposition can be envisaged, but the high temperatures demanded by this reaction are incompatible with those of the exhaust gases. Only catalytic reduction of oxides of nitrogen to nitrogen is possible using the reducing agents which are present, albeit in small quantities, in the exhaust gases (CO, H₂, unburned hydrocarbons or where combustion in the engine has been imperfect), and also by injecting a complement to those reducing compounds upstream of the catalyst. Such reducing agents are hydrocarbons, alcohols, ethers or other oxygen-containing compounds; they can also be a liquid or gaseous fuel (under pressure, CNG, or liquefied, LPG) feeding the engine or turbine.

European patent EP-A1-0 540 280 describes an apparatus for reducing emissions of oxides of nitrogen in the exhaust gases from internal combustion engines, which comprises a material for adsorbing and desorbing oxides of nitrogen. In that process, the oxides of nitrogen are stored in the form of nitrates when the engine is burning lean, i.e., depleted in hydrocarbons. However the storage capacity of a trap operating using that principle is generally deteriorated by adsorption of sulphur-containing products contained in the exhaust gas which form sulphates which are more stable than the nitrates, poisoning the trap.

Further, following NOₓ trapping, a step for desorbing the oxides of nitrogen must be carried out followed by their reduction. Devices for catalysed oxidation treatment of carbon monoxide CO and hydrocarbons HC contained in the exhaust gases are known which, for example, use catalysts for reducing oxides of nitrogen, known as DeNOₓ catalysts, which are active for reducing NOₓ in temperature ranges in the range 200° C. to 350° C. and which comprise, for example, precious metals on oxide supports such as platinum or palladium deposited on an alumina, titanium oxide or zirconium support, or by perovskites, or in temperature ranges in the range 350° C. to 600° C. comprising, for example, hydrothermally stable zeolites (for example Cu-ZSM5). A device for treating exhaust gases from a compression ignition engine comprising a catalyst and an oxides of nitrogen adsorbent placed in the exhaust collector has been described, for example, in patents EP-A1-0 540 280 and EP-A1-0 718 478.

Thus, a material behaving as a trap for oxides of nitrogen has to be capable of adsorbing the oxides of nitrogen at low temperatures up to the temperature necessary for the NOₓ reduction catalyst to function, the trap then allowing the oxides of nitrogen coming into contact with the DeNOₓ catalyst to desorb at a temperature sufficient to trigger the NOₓ reduction reaction.

EP-A2-1 055 806 describes a process combining the use of a NOₓ trap with a particle filter system.

French patent FR-A-2 733 924 describes a material with formula YBa₂Cu₃O₇₋ₓ which can integrate the oxides of nitrogen into the mixed oxide composing the material. That patent indicates that the material, after being charged with oxides of nitrogen, is transformed by changing from an orthorhombic structure which is rich in oxygen to a tetragonal structure which is depleted in oxygen when the oxygen content of the gas reduces, and that phase transition causes desorption of oxides of nitrogen. According to that process, it is possible to influence adsorption and desorption of the oxides of nitrogen by varying the amounts of oxygen in the exhaust gases. It has recently been demonstrated (K-Y Lee, K. Watanabe, M. Misono, Applied Catalysis B 13, 241 (1997)) that the adsorption of NOₓ in the presence of oxygen on the material YBa₂Cu₃O₇₋ₓ leads to the formation of barium nitrate species (Ba(NO₃)₂). That same study also showed that that material suffers a dramatic loss of its oxides of nitrogen adsorption properties in the presence of carbon dioxide by forming barium carbonates. Since barium sulphate species are more stable than the nitrate species, it is suspected that a compound of the YBa₂Cu₃O₇₋ₓ type would also be poisoned in the presence of sulphur dioxide by forming sulphate species on the oxides of nitrogen adsorption sites.

The materials of the present patent can be found in the natural state or they can be synthesised in the laboratory.

### SUMMARY OF THE INVENTION

The invention concerns materials for eliminating oxides of nitrogen NO and NO₂ (NOₓ), in particular those present in exhaust gases, for example internal combustion engines of automotive vehicles operating in a medium which is super-stoichiometric in oxidising agents, said materials being capable of adsorbing NOₓ and which can desorb NOₓ by raising the temperature or by treatment with a mixture which is rich in reducing agents. The materials are mixed oxides the framework of which is constituted by metal cations M each surrounded by 6 oxygen atoms and wherein the octahedra (MO₆) thus formed are connected together by edges and peaks generating a structure which produces lamellae between which the oxides of nitrogen can be inserted.

### SIGNIFICANCE OF THE INVENTION

The material of the invention with a lamellar structure can trap oxides of nitrogen at low temperatures and desorb them at the temperature at which a DeNOx catalyst is capable of reducing them. These materials are insensitive to the oxides of sulphur and carbon contained in the exhaust gases, which prevents the materials from being poisoned. The materials of the invention adsorb oxides of nitrogen over a wide temperature range while desorption is carried out in a very narrow temperature range, which means that thermal regeneration is easy to control. During desorption, the oxides of nitrogen which have been adsorbed are released in bursts with a high NOₓ concentration, which is beneficial to the reaction kinetics for reduction of the desorbed oxides of nitrogen. The kinetics of the reduction of NOₓ by hydrocarbons are positive with respect to the oxides of nitrogen species. Said material does not have a basic oxide phase, which substantially stabilises the oxides of nitrogen and oxides of sulphur into the nitrate and sulphate forms respectively. The SOₓ which can be inserted with the NOₓ into the structure of the material of the invention are desorbed in a temperature range which is similar to that of the NOₓ. Preventing the formation of stable sulphates ensures that poisoning of the adsorbing material is minimal, meaning that the regeneration frequency and the regeneration temperature are lower, and thus the service life of the NOₓ trap is longer, and there is an energy gain.

The material of the present invention can also allow chemical desorption by varying the chemical composition of the gas containing the oxides of nitrogen. In a particular implementation of the invention, combining the materials of the present invention with a metal from group VIII eliminates adsorbed NOₓ by reduction during passage of a rich mixture.

### DESCRIPTION OF THE INVENTION

The present invention concerns materials for adsorbing and desorbing oxides of nitrogen the structure of which is composed of octahedra (MO₆), M being selected from elements from groups IIIB to IVA in the periodic table or a mixture of at least two of said elements. Preferably, this element (M) has a mean oxidation number of close to 4. Said material has a characteristic lamellar structure into which the NOₓ can insert at low temperatures and leave at a higher temperature. The lamellae of these materials are formed by a two-dimensional linkage of the octahedra (MO₆) which connect together by the edges. This type of material is known by its acronym OL, meaning Octahedral Layer (a lamellar structure composed of octahedra). The material of the invention is a crystalline material with a two-dimensional structure.

The adsorbent phase of the material of the invention has a lamellar structure and is composed of octahedra (MO₆). It comprises:
at least one element (M) selected from the group formed by elements from groups IIIB, IVB, VB, VIB, VIIB, VIII, IB, IIB, IIIA and IVA of the periodic table or a mixture of at least two of those elements, each element M being co-ordinated with 6 oxygen atoms, and located at the centre of the oxygen octahedra;
at least one element (B) selected from the group formed by the alkali elements IA, the alkaline-earth elements IIA, the rare earths IIB, transition metals or elements from groups IIIA and IVA, element B generally being located in the space between the lamellae.

In one embodiment of the invention, the material optionally comprises at least one metal (C) selected from the group formed by precious metals from the platinum family (group VIII).

This embodiment allows subsequent reduction of NOₓ during adsorption then desorption. The material of the invention thus, surprisingly, enables three steps to be carried out with a single material.

Elements M are selected from scandium, yttrium, lanthanum, titanium, zirconium, hafnium, vanadium, niobium, tantalum, chromium, molybdenum, tungsten, manganese, rhenium, iron, cobalt, nickel, copper, silver, gold, zinc, cadmium, gallium, aluminium, indium, silicon, germanium and tin.

The mean of the charges (oxidation number) carried by the cation or cations M from groups IIIB to IVA is preferably about +4. At least the major portion of elements (M) is preferably selected from manganese, titanium, tin, tungsten, zirconium, molybdenum, chromium, niobium, vanadium or a mixture of at least two of these elements, preferably manganese, titanium, zirconium or tin. Other elements M from groups IIIB to IVA can be added in minor quantities as dopants. Preferably, the elements from groups IIIB to IVA added in minor quantities are selected from aluminium, zinc, copper, nickel, cobalt, iron, chromium, scandium, yttrium, gallium, cadmium and indium, and more preferably selected from aluminium, zinc, cadmium, scandium and yttrium.

Elements (B) belong to the group formed by the alkali elements IA, alkaline-earth elements IIA, rare earth elements IIIB, transition metals or elements from groups IIIA and IVA. They are located in the inter-lamellar spaces of the material. An alkali or alkaline-earth metal such as potassium, rubidium, magnesium, barium or strontium is preferred.

Elements (C) belong to the precious metal group of group VIII of the periodic table, i.e., to the group formed by platinum, palladium, rhodium, ruthenium, iridium and osmium. Preferably, element (C) is platinum, or a mixture of platinum and rhodium, of palladium and rhodium, or a mixture of platinum, rhodium and palladium. This embodiment of the invention comprising at least one element (C) selected from noble metals from group VIII can oxidise NO to NO₂.

The adsorbent phase of the invention has the following composition by weight, expressed as the percentage by weight with respect to the total mass of this active phase calcined at 1000° C. for 4 hours:
25% to 80% of at least one metal M, preferably 40% to 70%;
0.1% to 75%, preferably 5% to 45%, of at least one element (B) from the group formed by alkali elements IA, alkaline-earth elements IIA, rare earth elements IIIB, transition metals and elements from groups IIIA and IVA of the periodic table;
optionally, 0.05% to 5% of at least one metal (C) from the group formed by the precious metals from group VIII of the periodic table;
optionally, an inorganic support containing the metal (C).

The complement is formed by the oxygen of the oxide bonds.

The atomic ratio of element M to element B is generally 4 or less, preferably in the range 1. to 4.

A number of different methods exist for preparing such materials (S. L. Suib, C-L O'Young, “Synthesis of Porous Materials”, M. L. Occelli, H. Kessler, eds, M. Dekker, Inc., p. 215, 1997). They may be synthesised by mixing and grinding solid inorganic precursors of metals M and B, followed by calcining. The materials can also be obtained by heating solutions of precursor salts of M and B under reflux, drying and calcining, by precipitating the precursor salts or by hydrothermal synthesis which consists of heating an aqueous solution containing the elements constituting the final material under autogenous pressure. The solvents used during the syntheses are generally polar solvents, particularly water, acids or alcohols (methanol, ethanol, propanol-1 and -2, butanol, pentanol, hexanol . . . ). After precipitating the precursors, the structure of the materials can be obtained during the calcininging phase; depending on the nature of the precursors, it can also be obtained in solution during oxidation-reduction reactions between the precursors, which reactions can be facilitated by varying the temperature of the solution or by modifying the pH of the solutions. The solvent can sometimes act as the reducing agent, for example an alcohol, a polyalcohol (sugar, etc), or acids. To produce an acidic pH, an inorganic acid (HCl, HNO₃, H₂SO₄, H₂O₂, etc) or an organic acid (for example CH₃COOH) ca be added; similarly, to obtain a basic pH, it is possible to use suitable bases such as ammonia, sodium hydroxide, potassium hydroxide, or even organic bases (urea, etc.).

The materials obtained from these syntheses can also be modified by ion exchange or isomorphous substitution.

Optional metal (C) is introduced using any of the methods known to the skilled person: in particular, it can be deposited directly on to the adsorption phase by excess impregnation, dry impregnation, ion exchange, or it may already have been dispersed on an inorganic support before being mechanically mixed with the adsorbent phase.

The material of the invention generally has a specific surface area in the range 3 to 250 m²/g.

The adsorbent phases can be in the form of a powder, beads, pellets or extrudates; they can also be deposited or directly prepared on monolithic supports of ceramic or metal: Advantageously, in order to increase the dispersion of the materials and thus to increase their capacity to adsorb NOₓ, the materials can be deposited on large specific surface area porous supports such as silica SiO₂, alumina Al₂O₃ (alpha, beta, delta, gamma, khi, or theta alumina), titanium oxide TiO₂, zirconium oxide ZrO₂, divided carbides, for example silicon carbides (SiC), used alone or as a mixture, magnesium oxide, prior to forming (extrusion, coating, etc). It is also possible to use silica-alumina or zeolite supports. Mixed oxides or solid solutions comprising at least two of the above oxides can be added.

However, for use in a vehicle, it is usually preferable to use rigid supports (monoliths) with a large open porosity (more than 70%) to limit pressure drops which may cause high gas flow rates, and in particular high exhaust gas space velocities. These pressure drops are deleterious to proper functioning of the engine and contribute to reducing the efficiency of an internal combustion engine (gasoline or diesel). Further, the exhaust system is subjected to vibrations and to substantial mechanical and thermal shocks, so catalysts in the form of beads, pellets or extrudates run the risk of deterioration due to wear or fracturing.

Two techniques are used to prepare the catalysts of the invention on monolithic ceramic or metal supports (or substrates).

The first technique comprises direct deposition on the monolithic support, using a wash coating technique which is known to the skilled person. The adsorbent phase can be coated just after the co-precipitation step, hydrothermal synthesis step or heating under reflux step, the final calcining step being carried out on the phase deposited on the monolith, or the monolith can be coated after the material has been prepared in its final state, i.e., after the final calcining step.

The second technique comprises firstly depositing the inorganic oxide on the monolithic support then calcining the monolith between 500° C. and 1100° C. so that the specific surface area of this oxide is in the range 20 to 150 m²/g, then coating the monolithic substrate covered with the inorganic oxide with the adsorbent phase.

Monolithic supports which can be used are:
either ceramic, where the principal elements can be alumina, zirconia, cordierite, mullite, silica, alumino-silicates or a combination of several of these compounds;
or a silicon carbide and/or nitride;
or aluminium titanate;
or of metal, generally obtained from iron, chromium or aluminium alloys optionally doped with nickel, cobalt, cerium or yttrium.

The structure of the ceramic supports is that of a honeycomb, or they are in the form of a foam or fibres.

Metal supports can be produced by winding corrugated strips or by stacking corrugated sheets to constitute a honeycomb structure with straight or zigzag channels which may or may not communicate with each other. They can also be produced from metal fibres or wires which are interlocked, woven or braided.

With supports of metal comprising aluminium in their composition, it is recommended that they be pre-treated at high temperature (for example between 700° C. and 1100° C.) to develop a micro-layer of refractory alumina on the surface. This superficial micro-layer, with a porosity and specific surface area which is higher than that of the original metal, encourages adhesion of the active phase and protects the remainder of the support against corrosion.

The quantity of adsorbent phase deposited or prepared directly on the ceramic or metallic support (or substrate) is generally in the range 20 to 300 g per litre of said support, advantageously in the range 50 to 200 g per litre.

The materials of the invention can thus adsorb and desorb oxides of nitrogen present in the gases, in particular exhaust gases.

These materials are characterized in that they are capable of adsorbing NOₓ at a temperature which is generally in the range 50° C. to 450° C., preferably in the range 150° C. to 350° C., more preferably in the range 200° C. to 350° C. Said oxides of nitrogen can be desorbed at a temperature generally in the range 300° C. to 550° C., preferably in the range 400° C. to 500° C. They can also be desorbed by varying the composition of the gas, for example by suddenly increasing the concentration of reducing compounds such as hydrocarbons, hydrogen, carbon monoxide, at temperatures in the range 150° C. to 550° C., preferably in the range 200° C. to 450° C., more preferably in the range 300° C. to 400° C. Thermally or chemically, oxides of nitrogen desorption can be triggered in temperature ranges where conventional NOₓ reduction catalysts are effective. Further, the thermal desorption of the invention can take place within narrow ranges of temperature generally within an amplitude of 80° C. For diesel cars, the temperature of the exhaust gas is generally in the range 150° C. to 300° C. and rarely exceeds 500° C. The materials used in the process of the invention are thus suitable for adsorbing oxides of nitrogen present in the exhaust gases of stationary engines or, particularly, automotive diesel engines or spark ignition (lean burn) engines, but also in the gases from gas turbines operating with gas or liquid fuels. These gases are also characterized by oxides of nitrogen contents of a few tens to a few thousands of parts per million (ppm) and can contain comparable amounts of reducing compounds (CO, H₂, hydrocarbons) and sulphur, also large quantities of oxygen (1% to close to 20% by volume) and steam. The material of the invention can be used with HSVs (hourly space velocity, corresponding to the ratio of the volume of the monolith to the gas flow rate) of the exhaust gas generally in the range 500 to 150000 h⁻¹, for example in the range 5000 to 100000 h⁻¹.

The invention also concerns the use of materials for adsorbing and desorbing oxides of nitrogen in a process for eliminating oxides of nitrogen, more particularly in a medium which is super-stoichiometric in oxidising agents. Thus, the material of the invention can be used in a process comprising:
a step for adsorbing at least a portion of said oxides of nitrogen onto an adsorption material as defined in the present invention;
a step for desorbing the oxides of nitrogen carried out by increasing the temperature or by varying the composition of the exhaust gases;
a step for selective reduction of at least a portion of the oxides of nitrogen to molecular nitrogen by reducing agents in the presence of at least one catalyst for reducing oxides of nitrogen.

Thus, the process for eliminating oxides of nitrogen comprises, during the step for reducing the oxides of nitrogen, using a catalyst which is active and selective for reducing oxides of nitrogen to molecular nitrogen in a medium which is super-stoichiometric in oxidising agents. Catalysts for reducing oxides of nitrogen to nitrogen or nitrous oxide generally comprise at least one inorganic refractory oxide and can comprise at least one zeolite selected, for example, from MFI, NU-86, NU-87 and EU-1 zeolites and generally at least one element selected from elements from transition metal groups VIB, VIIB, VIII and IB. These catalysts can optionally contain at least one element selected from noble metals from group VIII, for example platinum, rhodium, ruthenium, iridium, palladium and optionally at least one element selected from elements from groups IIA, the alkaline-earths and IIIB, the rare earths. Examples of catalysts for reducing oxides of nitrogen include the following combinations: Cu-ZSM5, Cu-MFI, Fe-MFI, Fe-ZSM5, Ce-MFI, Ce-ZSM5, Pt-MFI, Pt-ZSM5.

The refractory inorganic oxide is selected from supports of the type Al₂O₃, SiO₂, ZrO₂ and TiO₂, preferably alumina.

The reducing agents are selected from CO, H₂, hydrocarbons, present in the fuel or added in the form of fresh products.

In the case where the material for adsorbing oxides of nitrogen of the present invention contains at least one element (C) selected from noble metals from group VIII of the periodic table, the process for eliminating oxides of nitrogen comprises:
a step for adsorbing at least a portion of said oxides of nitrogen on the material as defined in the present invention;
a step for desorbing the oxides of nitrogen;
a step for selective reduction of at least a portion of the oxides of nitrogen to molecular nitrogen in the presence of reducing compounds on the material as defined in the present invention.

Thus, reducing oxides of nitrogen to nitrogen or nitrous oxide can take place directly on the adsorption material of the invention, which permits both trapping of the oxides of nitrogen, desorption of said oxides of nitrogen and reduction thereof.

Advantageously, for use in a process for eliminating oxides of nitrogen comprising an adsorption step then a step for desorbing oxides of nitrogen, the material of the invention is installed upstream of a particle filter or is directly coated onto the walls of a particle filter.

### EXAMPLES

Examples 1 to 6 and 9 to 13 below illustrate the invention without in any way limiting its scope.

Examples 7 and 8 describe prior art materials used to trap NOₓ.

For comparison purposes, all of these catalysts were tested in the laboratory in a micro-unit with a synthetic gas mixture.

In all of the examples, the designation of the adsorbent phase deposited on the support (or substrate) corresponded to the sum of the elements constituting the material described in the above procedure after the loss on ignition, namely: the elements (M) contained in the centre of the oxygen octahedra, at least one element (B), and at least one optional noble metal (C).

The weight contents of the different elements constituting the adsorbent phase are shown in Table 1 as a percentage. The oxygen in the oxide phases is not taken into account in the material balance.

### Example 1

### Invention

Three aqueous solutions of 150 ml containing 20 g of MnAc₂.4H₂O, 90 g of KOH and 5.1 g of KmnO₄ respectively were mixed. The mixture was heated under reflux for 24 hours. The precipitate was filtered, then it was washed and oven dried at 100° C. Before use, it was calcined in air at 700° C.

### Example 2

### Invention

Three aqueous solutions of 150 ml containing 20 g of MnAc₂.4H₂O, 90 g of KOH and 5.1 g of KmnO₄ respectively were mixed. The mixture was allowed to mature at ambient temperature for one week. The precipitate was filtered, then it was washed and oven dried at 100° C. Before use, it was calcined in air at 700° C.

### Example 2

### bis Invention

20 g of MnAc₂.4H₂O, 3.5 g of MgAc₂.4H₂O, 90 g of KOH and 5.1 g of KmnO₄ were added to 450 ml of water. The mixture was allowed to mature at ambient temperature for one week. The precipitate was filtered, then it was washed and oven dried at 100° C. Before use, it was calcined in air at 700° C.

### Example 3

6 g of MnAc₂.4H₂O and 2.6 g of KmnO₄ were dissolved in two litres of ethanol. The mixture was heated under reflux for 2 hours, then the solvent was extracted under vacuum. The precipitate was oven dried at 100° C. then calcined in air at 700° C.

### Example 4

10 g of glucose was dissolved in 40 ml of water and 6 g of KmnO₄ was dissolved in 100 ml of water. The second solution was rapidly added to the first. The gel formed was dried, then it was calcined in air at 700° C.

### Example 5

K₂CO₃ and TiO₂ (anatase form) were mixed mechanically in a mole ratio of 1:35 then heated for 30 hours at 800° C.

### Example 6

RbMnO₄ and TiO₂ (anatase form) were mixed mechanically in a mole ratio of 3:5 then heated for 20 hours at 1000° C.

### Example 7 (Comparative)

A material for occluding NOₓ with formula YBa₂Cu₃O₇₋ₓ was prepared using the technique described in EP-A-0 664 147, and had a perovskite structure (verified by X-ray diffraction).

### Example 8 (Comparative)

The material with formula Pt—Rh/Ba—La—CeO₂—Al₂O₃—TiO₂ as described in European patent application EP-A-0 666 103 was used to trap NOₓ by nitrate formation.

### Example 9

### Invention

The catalyst of Example 1 was reproduced, water having been added to produce a suspension and to enable a wash coat to be formed on cordierite monoliths (cell density: 400 cpsi, namely 620 cells/cm², or 6.20×10⁵ cells/m², “cpsi” meaning cells per square inch). After calcining at 550° C., the amount of coated material corresponded to 100 grams of dry matter per litre of monolith.

### Example 10

### Invention

The coated cordierite monolith of Example 9 was reproduced, on which platinum and rhodium were deposited by dry impregnation from a solution of Pt(NH₃)₄(NO₃)₂ and Rh(NO₃)₃.

TABLE I
Composition by weight of materials prepared in Examples 1 to 7

| | | S_{BET} | | | | | | | | | | | | | | |
|---|---|---|---|---|---|---|---|---|---|---|---|---|---|---|---|---|
| Examples | Materials | (m²/g) | K | Rb | Mg | Ba | La | Ce | Y | Cu | Zn | Mn | Ti | Al | Pt | Rh |
| Example 1 | K—Mn | 7 | 11.3 | | | | | | | | | 54.4 | | | | |
| (inv) | | | | | | | | | | | | | | | | |
| Example 2 | K—Mn | 29 | 20.8 | | | | | | | | | 46.1 | | | | |
| (inv) | | | | | | | | | | | | | | | | |
| Example | K—Mg—Mn | 9 | 15.5 | 3.3 | | | | | | | | 46.1 | | | | |
| 2bis (inv) | | | | | | | | | | | | | | | | |
| Example 3 | K—Mn | 8 | 14.4 | | | | | | | | | 47.6 | | | | |
| (inv) | | | | | | | | | | | | | | | | |
| Example 4 | K—Mn | 7 | 10.6 | | | | | | | | | 53.4 | | | | |
| (inv) | | | | | | | | | | | | | | | | |
| Example 5 | K—Ti | 6 | 18.9 | | | | | | | | | | 40.8 | | | |
| (inv) | | | | | | | | | | | | | | | | |
| Example 6 | Rb—MnTi | 3 | | 28 | | | | | | | | 18.0 | 26.0 | | | |
| (inv) | | | | | | | | | | | | | | | | |
| Example 7 | YbaCuO | 4 | | | | 41.7 | | | 13.5 | 29.0 | | | | | | |
| (comp) | | | | | | | | | | | | | | | | |
| Example 8 | Pt—Rh/Ba—La—CeO₂—Al₂O₃—TiO₂ | 120 | | | | 18 | 3 | 11 | | | | | 8.5 | 18.1 | 0.5 | 0.05 |
| (comp) | | | | | | | | | | | | | | | | |
| Example 9 | K—Mn-monolith | 8 | 10.2 | | | | | | | | | 53.7 | | | | |
| (inv) | 100 g/l | | | | | | | | | | | | | | | |
| Example | Pt—Rh/K—Mn | 7 | 10.1 | | | | | | | | | 52.8 | | | 0.5 | 0.05 |
| 10 (inv) | monolith | | | | | | | | | | | | | | | |
| | 100 g/l | | | | | | | | | | | | | | | |

### Example 11

### Results of Thermal Adsorption-Desorption Tests for Oxides of Nitrogen

The test materials were installed in a micro-reactor placed in the centre of a furnace. They underwent pre-treatment at 600° C. for 5 hours in a gas mixture constituted by nitrogen containing 18.5% of O₂ and 4% of H₂O. With the same mixture, these materials were brought to different temperatures (T) in the range 150° C. to 400° C., when a gaseous mixture containing oxides of nitrogen was passed for 20 minutes.

| | |
|---|---|
| Hourly space velocity (HSV) | 5000 h⁻¹ |
| Composition of mixture | |
| NOₓ | 800 ppm: NO 650 ppm, NO₂ 150 ppm |
| O₂ | 18.5% |
| H₂O | 4% |
| N₂ | complement to 100% |

After twenty minutes of adsorption, the supply of oxides of nitrogen was cut off and the materials were heated to desorb the NOₓ:

| Hourly space velocity (HSV) | 5000 | h⁻¹ |
|---|---|---|
| Composition of mixture | | |
| O₂ | 18.5% | |
| H₂O | 4% | |
| N₂ | complement to 100% | |
| Desorption temperature range | from T_{ads} to 600° C. | |
| Temperature change | 10° | C./min |

Table II below shows the values indicating the quantity of oxides of nitrogen adsorbed and the desorption temperature of these oxides. With the exception of the materials of Example 8 which already contained platinum in its composition, the results for the adsorption of the materials prepared above are supplemented by those for the same compounds to which a Pt/SiO₂ phase had been added, equivalent to a weight percentage of 1% with respect to the total mass of the mixture. It was verified that; under our conditions, this Pt/SiO₂ phase did not act as an adsorbing mass for oxides of nitrogen.

TABLE II
Results of micro-unit adsorption - desorption tests

| | | Capacity (mgNO/g) at different adsorption | | | | | |
|---|---|---|---|---|---|---|---|
| | | temperatures | | | | | T desorption |
| Ex. | Materials | 150° C. | 200° C. | 300° C. | 350° C. | 400° C. | (° C.) |
| 1 (inv) | K—Mn | 4 | 5 | 11 | 11.5 | | 485 |
| 2 (inv) | K—Mn | 3.2 | 3.8 | 6.5 | 6.8 | | 530 |
| 2bis | K—Mg—Mn | 6.5 | 8.7 | 12.1 | 13 | | 480 |
| (inv) | | | | | | | |
| 2bis | K—Mg—Mn + | 8.5 | 10.5 | 12.5 | | | 420 |
| (inv) | Pt/SiO₂ | | | | | | |
| 3 (inv) | K—Mn | 5.0 | 8.5 | 11.6 | 14 | 14 | 510 |
| | | | | | 28* | | |
| 3 (inv) | K—Mn + | 6.0 | 9.0 | 12.2 | | | 450 |
| | Pt/SiO₂ | | | | | | |
| 4 (inv) | K—Mn | 4.7 | 8.2 | 11.8 | | | 445 |
| 5 (inv) | K—Ti | 2.1 | 2.8 | 1.6 | | | 465 |
| 6 (inv) | Rb—MnTi | 1.5 | 2.8 | 2.1 | | | 400 |
| 7 | YBaCuO | | 1.1 | 1.4 | | 3.2 | 490 |
| (comp) | | | | | | | |
| 7 | YBaCuO + | | | 3.4 | | 3.2 | 485 |
| (comp) | Pt/SiO₂ | | | | | | |
| 8 | PtRh—Ba—Ce—La/ | | 6.1 | | 8.2 | | 570 |
| (comp) | TiO₂—Al₂O₃ | | | | | | |

*After adsorption for 90 minutes.

It can be seen that the materials of the invention, particularly when they do not contain a platinum phase, are more effective for adsorbing oxides of nitrogen than the comparative test materials. The materials of the present invention thus have the advantage of being highly adsorbent, without the constraint of the presence of platinum. Further, the materials of the present invention have a relatively low oxides of nitrogen desorption temperature, suitable for application in a diesel engine exhaust line.

Beyond 150° C., the materials of the present invention have a satisfactory adsorption capacity, which means that a wide range of temperatures can be used (150-350° C.). Analysis of the gas at the outlet from the micro-reactor showed that up to their saturation, the materials of the present invention adsorb all of the NOₓ (whether NO or NO₂) with which they come into contact between 50° C. and the desorption temperature; for this reason, the performance of the materials of the present invention is good, even in the absence of an oxidising phase (for example supported Pt).

### Example 12

### Results of Thermal NOₓ Adsorption—Desorption Tests at a High HSV and in the Presence of Hydrocarbons and CO₂

The material of Example 9 was installed in a reactor placed in the centre of a furnace. It underwent pre-treatment at 600° C. for 5 hours in a gas mixture constituted by nitrogen containing 18.5% O₂, 5% CO₂, 4% H₂O and 2000 ppm of C in C₂H₄. In the same mixture, these materials were brought to a temperature of 300° C., where a gas mixture containing oxides of nitrogen was passed for 20 minutes.

| | |
|---|---|
| Hourly space velocity (HSV) | 50000 h⁻¹ |
| Composition of mixture | |
| NOₓ | 800 ppm: NO 650 ppm, NO₂ 150 ppm |
| O₂ | 18.5% |
| H₂O | 4% |
| CO₂ | 5% |
| C₂H₄ | 2000 ppm C |
| N₂ | complement to 100% |

After twenty minutes of adsorption, the supply of oxides of nitrogen was cut off and the materials were heated to desorb the NOₓ:

| Hourly space velocity (HSV) | 50000 | h⁻¹ |
|---|---|---|
| Composition of mixture | | |
| O₂ | 18.5% | |
| H₂O | 4% | |
| CO₂ | 5% | |
| C₂H₄ | 2000 ppm C | |
| N₂ | complement to 100% | |
| Desorption temperature range | 300° C. to 600° C. | |
| Temperature change | 10° | C./min |

Table III below indicates the quantity of oxides of nitrogen adsorbed and the desorption temperature of these oxides for the material of Example 9; they are compared with the results obtained under the preceding conditions for the same material.

It can be seen that the materials of the present invention represented by Example 1 and Example 9 (the material of Example 9 differing from that of Example 1 only in the presence of a support) have a comparable efficiency for adsorption of oxides of nitrogen whether the HSV is 5000 or 50000 h⁻¹. Further, if the mixture is rendered more complex by adding other gaseous molecules (CO₂, C₂H₄) routinely contained in exhaust gases and the size of which could allow them to become adsorbed onto the same sites as NOₓ, it can be seen that the adsorption capacity is only reduced by about 30%.

Such results suggest that the materials of the present invention can be used to trap oxides of nitrogen contained in exhaust gases, moving at high HSVs and containing gaseous molecules other than NOₓ.

The desorption temperatures for the oxides of nitrogen trapped in the material are not significantly modified either by increasing the HSV or by the presence of other molecules adsorbed on the material.

TABLE IV
Adsorption test results

| | | Composition of | Composition of | Capacity | |
|---|---|---|---|---|---|
| | HSV | mixture during | mixture during | at 300° C. | T_{des} |
| Ex | (h⁻¹) | pre-treatment | adsorption | (mgNO/g) | (° C.) |
| 1 (inv) | 5000 | O₂, H₂O, N₂ | NO, O₂, H₂O, N₂ | 11.0 | 485 |
| 9 (inv) | 50000 | O₂, H₂O, N₂ | NO, O₂, H₂O, N₂ | 9.0 | 455 |
| 9 (inv) | 50000 | O₂, CO₂, H₂O, | NO, O₂, CO₂, | 6.4 | 475 |
| | | C₂H₄, N₂ | H₂O, C₂H₄, N₂ | | |

### Example 13

### Results of Adsorption—Desorption Tests by Varying the Relative Mixture Strength, and Influence of Sulphur

The materials of Examples 9 and 10 were installed in a reactor placed in the centre of a furnace. They underwent pre-treatment at 600° C. for 5 hours in a gas mixture constituted by nitrogen containing 18.5% of O₂ and 4% of H₂O then were brought to 350° C. in the same mixture. A gas containing oxides of nitrogen the composition of which was transitory was then passed over the materials, the gas being alternately composed of a mixture which was lean in CO and rich in O₂ for 90 seconds, then a mixture which was rich in CO and lean in O₂ for 30 sec.

| Hourly space velocity (HSV) | 50000 | h⁻¹ |
|---|---|---|
| Composition of lean | | |
| mixture (R = 0.3) | | |
| NOₓ | 400 | ppm |

| | |
|---|---|
| CO | 0.1% |
| CO₂ | 5% |
| HC | 3000 ppm of C |
| O₂ | 18.5% |
| H₂O | 4% |
| N₂ | Complement to 100% |
| SO₂ | 20 ppm (test with sulphur only) |
| Composition of rich | |
| mixture (R = 1.2) | |
| NOₓ | 400 ppm (NO 390 ppm, NO₂ 10 ppm) |
| CO | 6% |
| CO₂ | 5% |
| HC | 3000 ppm of C |
| O₂ | 2% |
| H₂O | 4% |
| N₂ | Complement to 100% |
| SO₂ | 20 ppm (test with sulphur only) |

The accompanying Figure I shows the mode of operation of the material of Example 9 at the 350° C. stage in the absence of sulphur.

At each lean phase, the material adsorbed a large quantity of oxides of nitrogen, most of which was desorbed without being modified when passing the rich medium.

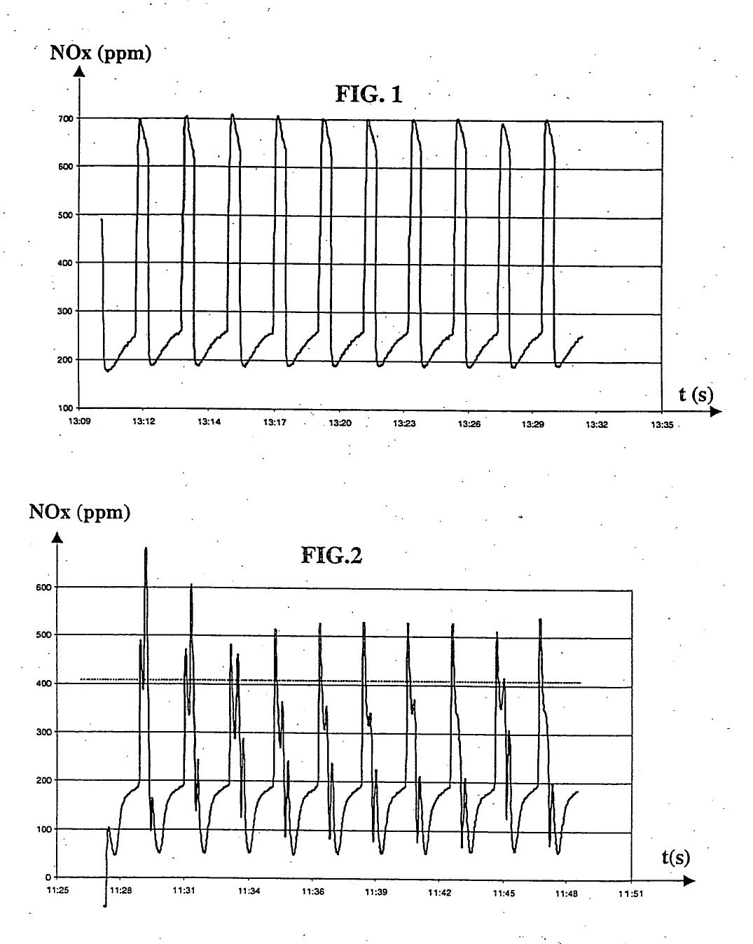

FIG. 2 shows the mode of operation of the material of Example 10 at the 350° C. stage in the absence of sulphur. The difference between the material of Example 9 and that of Example 10 is the presence of impregnated noble metal.

It can be seen that the presence of a precious metal improves the adsorption capacity of the material in the lean phase, but above all can eliminate oxides of nitrogen adsorbed during the lean phase during the rich phase.

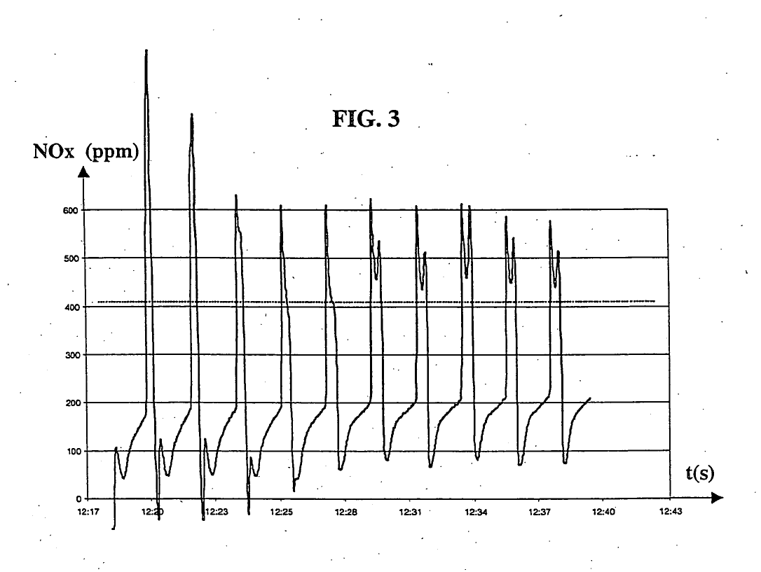

FIG. 3 shows the mode of operation of the material of Example 10 at the 350° C. stage in the presence of sulphur (200 ppm in the gas phase). This amount of sulphur admitted into the gas phase approximately represents an amount of sulphur in the fuel of the order of 350 ppm.

It can be seen that the NOₓ adsorption and reduction capacities of the material claimed by the Applicant are not affected by the presence of sulphur.

1. A material for eliminating oxides of nitrogen from exhaust gases, in particular from automotive vehicle internal combustion engines, comprising an adsorbent phase including MO₆ octahedra comprising at least one element M selected from elements from groups IIIB, IVB, VB, VIB, VIB, VIIB, VIII, IB, IIB, IIIA and IVA of the periodic table or a mixture of at least two of said elements, said octahedra connecting together to form a lamellar structure, and further comprising at least one element (B) selected from the group formed by the alkaline elements, the alkaline-earth elements, the rare earth elements, the transition metals and elements from groups IIIA, IVA of the periodic table and located in the interlamellar space.

2. A material according to claim 1, characterized in that the average valency of the metals M is about +4.

3. A material according to claim 1, characterized in that at least the major portion of element M is selected from manganese, tungsten, zirconium, titanium, tin, molybdenum, chromium, niobium, vanadium, or a mixture of at least two of said elements.

4. A material according to claim 3, characterized in that said material further comprises at least one element M selected from aluminum, zinc, cadmium, copper, nickel, cobalt, iron, chromium, scandium, gallium, yttrium and indium.

5. A material according to claim 1, further comprising at least one metal (C) selected from noble metals from group VIII of the periodic table.

6. A material according to claim 5, characterized in that said element (C) is platinum, a mixture of platinum and rhodium, palladium and rhodium, or a mixture of platinum, rhodium and palladium.

7. A material according to claim 5, characterized in that the element (C) is deposited directly on to the adsorbent phase or is dispersed on an inorganic support in advance before being mixed with the adsorbent phase.

8. A material according to claim 1 comprising, as a percentage by weight:
25% to 80% of at least one metal M;
0.1% to 75% of at least one element (B);
optionally, 0.05% to 5% of at least one metal (C), a noble metal from group VIII of the periodic table;
optionally, an inorganic support containing the metal (C).

9. A material according to claim 1, characterized in that the specific surface area of said material is in the range 3 to 250 m²/g.

10. A material according to claim 1, characterized in that said material comprises at least one porous support.

11. A material according to claim 10, characterized in that the porous support is selected from the following compounds: SiO₂, Al₂O₃, TiO₂, ZrO₂, SiC, MgO, silica-alumina and zeolite.

12. A material according to claim 1, characterized in that it comprises at least one rigid support.

13. In a process for eliminating oxides of nitrogen comprising adsorbing oxides of nitrogen on an adsorbent-phase, at a temperature in the range 50° C. to 450° C., the improvement when the adsorption phase comprises the material according to claim 1.

14. A process according to claim 13 in a process for eliminating oxides of nitrogen, further comprising a step for desorbing the oxides of nitrogen implemented by raising the temperature.

15. A process according to claim 14, characterized in that thermal desorption of the oxides of nitrogen is carried out at a temperature in the range 300° C. to 550° C.

16. A process according to claim 13 in a process for eliminating oxides of nitrogen, further comprising a step for desorbing the oxides of nitrogen implemented by varying the gas composition.

17. A process according to claim 16, characterized in that chemical desorption of the oxides of nitrogen is carried out at a temperature in the range 150° C. to 550° C.

18. A process according to claim 13 in a process for eliminating oxides of nitrogen, further comprising a step for reducing oxides of nitrogen to molecular nitrogen and/or nitric oxide.

19. A process according to claim 18, in which the oxides of nitrogen are reduced in the presence of a catalyst comprising at least one inorganic refractory oxide, optionally at least one zeolite, at least one element selected from elements from transition metal groups VIB, VIIB, VIII and IB, optionally at least one element selected from the noble metals of group VIII, and optionally at least one element selected from elements from the alkaline-earth group IIA, and the rare earth group IIIB.

20. A process according to claim 18, in which the step for adsorbing the oxides of nitrogen, the step for desorbing the oxides of nitrogen and the step for reducing the oxides of nitrogen take place in the presence of a said material comprising an adsorbent phase and further comprising at least one noble metal © from group VIII of the periodic table.

21. A process according to claim 13, in which the material is installed upstream of a particle filter or is directly coated onto the walls of a particle filter.

22. A process according to claim 13, in an exhaust gas for vehicle internal combustion engines.

23. A process according to claim 22 in a Diesel type motor or a lean burn engine.

24. A method according to claim 1 wherein said at least one element (B) comprises an alkali or alkaline-earth metal.

25. A method according to claim 3 wherein said at least one element (B) comprises an alkali or alkaline-earth metal.

26. A method according to claim 4 wherein said at least one element (B) comprises an alkali or alkaline-earth metal.
